(19) United States
(12) Patent Application Publication
(10) Pub. No.: US 2008/0111314 A1
(43) Pub. Date: May 15, 2008

(54) SHAFT SEALING ASSEMBLY WITH LIQUID STIRRING UNIT

(76) Inventor: Cheng-Shiou Huang, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/558,158

(22) Filed: Nov. 9, 2006

(51) Int. Cl. F16J 15/34; F16J 15/16

(52) U.S. Cl. 277/354; 277/408

(57) ABSTRACT

A shaft sealing assembly includes a sealing device and a stirring unit. The sealing device includes a plurality of non-rotational members and a plurality of rotational members. The non-rotational members include a main body and a fixed frictional ring. The rotational members include a shaft tube and a rotational frictional ring. The fixed frictional ring abuts against the rotational frictional ring, forming an abutting section between the fixed frictional ring and the rotational frictional ring. The stirring unit is provided on one of the rotational members for driving a liquid adjacent to the abutting section to create stirring currents for stirring the liquid adjacent to the abutting section.

### BACKGROUND OF THE INVENTION

1. Field of the Invention

The present invention relates to a shaft sealing assembly. More particularly, the present invention relates to a shaft sealing assembly with a liquid stirring unit for stirring liquid to prevent accumulation of solid substances and to enhance heat-dissipating effect.

2. Description of Related Art

U.S. Pat. No. 6,935,633 discloses a shaft sealing device including a shaft tube, a main body, a fixed sealing ring, a positioning ring and a retaining ring. The shaft tube is provided with an outer flange and a rotary ring mounted thereto. The main body has an axial hole for supporting the shaft tube which is rotatably extended therethrough. The fixed sealing ring and the retaining ring are inserted in the axial hole of the main body while the positioning ring being mounted in the axial hole. The fixed sealing ring, the retaining ring and the positioning ring are disposed on the shaft tube in loose fit manner to allow for rotation. The fixed sealing ring has a first side to abut against the rotary ring, and a second side to connect to the retaining ring. The positioning ring is provided with elastic members adapted to bias the retaining ring against the fixed sealing ring.

The shaft tube is fixed by screw members on a rotary shaft of a motor, and the main body is fixed to a sidewall of a liquid container. When the motor turns, the rotary shaft rotates to stir the liquid received in the container, with the shaft sealing device preventing the liquid from leaking via a gap between the rotary shaft and the liquid container.

However, suspended impurities in the liquid are liable to be accumulated in a gap or space between the shaft tube and the main body where the liquid flows slowly or even becomes still. The accumulated impurities adversely affect the rotational smoothness between the rotary shaft and the main body and the frictional engagement between the rotary ring and the fixed sealing ring, resulting in an increase in rotational friction and high temperature. As a result, the life of the shaft sealing device is shortened.

### OBJECTS OF THE INVENTION

An object of the present invention is to provide a shaft sealing assembly having a stirring unit for creating stirring currents to prevent undesired accumulation of suspended impurities in the liquid.

Another object of the present invention is to provide a shaft sealing assembly having a stirring unit that maintains rotational smoothness.

A further object of the present invention is to provide a shaft sealing assembly having a stirring unit that enhances heat-dissipating effect.

Still another object of the present invention is to provide a shaft sealing assembly having a stirring unit that prolongs the life of the shaft sealing assembly.

### SUMMARY OF THE INVENTION

A shaft sealing assembly in accordance with the present invention comprises a sealing device and a stirring unit. The sealing device includes a plurality of non-rotational members and a plurality of rotational members. The non-rotational members include a main body and a fixed frictional ring. The rotational members include a shaft tube and a rotational frictional ring. The fixed frictional ring abuts against the rotational frictional ring, forming an abutting section between the fixed frictional ring and the rotational frictional ring. The stirring unit is provided on one of the rotational members for driving a liquid adjacent to the abutting section to create stirring currents for stirring the liquid adjacent to the abutting section.

The stirring unit may be provided on an outer circumference of the shaft tube.

The stirring unit may include at least one helical blade or at least one helical groove.

The rotational members may further include a rotary shaft, and the stirring unit is provided on an outer circumference of the rotary shaft.

The rotary shaft may include a shaft body and a sleeve fixed around the shaft body, and the stirring unit is provided on the shaft body or the sleeve.

Alternatively, the stirring unit is provided on an inner circumference of the rotational frictional ring.

Preferably, the rotational frictional ring includes an abutting face, and the fixed frictional ring includes an abutting face that abuts against the abutting face of the rotational frictional ring to form the abutting section.

Preferably, the stirring unit is adjacent to the abutting section.

Other objects, advantages and novel features of this invention will become more apparent from the following detailed description when taken in conjunction with the accompanying drawings.

### BRIEF DESCRIPTION OF THE DRAWINGS

FIG. 1 is a sectional view illustrating a first embodiment of a shaft sealing assembly in accordance with the present invention;

FIG. 2 is a sectional view illustrating a second embodiment of the shaft sealing assembly in accordance with the present invention; and

FIG. 3 is a sectional view illustrating a third embodiment of the shaft sealing assembly in accordance with the present invention.

### DETAILED DESCRIPTION OF THE PREFERRED EMBODIMENTS

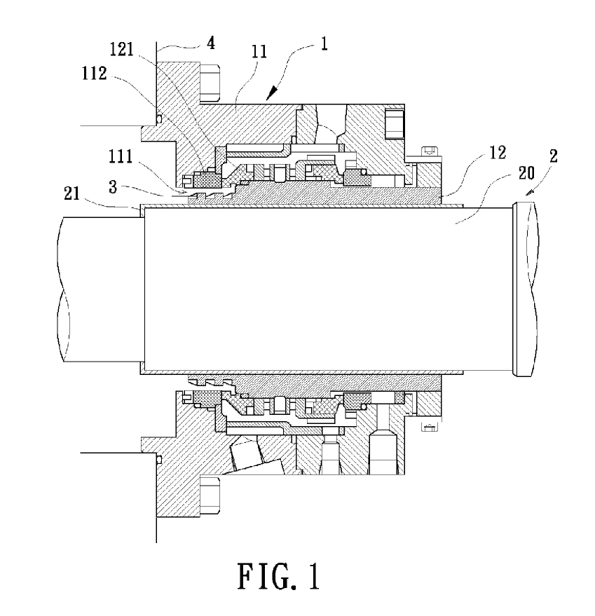

Referring to FIG. 1, a first embodiment of a shaft sealing assembly in accordance with the present invention comprises a sealing device 1, a rotary shaft 2, and a stirring unit 3. The sealing device 1 includes a main body 11 and a shaft tube 12. The main body 11 is fixed to a sidewall of a liquid container 4 and includes an axial hole 111 in which a fixed frictional ring 112 is mounted. The fixed frictional ring 112 includes an abutting face (not labeled), which will be described later.

The shaft tube 12 and the rotary shaft 2 are mounted in the axial hole 111 that extends through a center of the main body 11. The fixed frictional ring 112 is fixed to an inner circumferential wall defining the axial hole 111 and around the shaft tube 12. The rotary shaft 2 extends through and is fixed to the shaft tube 12. A rotational frictional ring 121 is mounted around an outer circumference of the shaft tube 12 and faces the fixed frictional ring 112. The rotational frictional ring 121 has an abutting face (not labeled) that tightly abuts against the abutting face of the fixed frictional ring 112 to form an abutting section. By such an arrangement, the shaft tube 12 rotates relative to the main body 11 along the abutting section while preventing the liquid received in the liquid container 4 from leaking via the gap (not labeled) between the main body 11 and the shaft tube 12.

The parts of the sealing device 1 include non-rotational members and rotational members. The non-rotational members include the main body 11, the fixed frictional ring 112, and other members (not labeled) fixed to the liquid container 4. The rotational members include the shaft tube 12, the rotational frictional ring 121, and other members that rotate synchronously with the rotary shaft 2.

Still referring to FIG. 1, the rotary shaft 2 extends into an interior (not labeled) of the liquid container 4 and is rotatable relative to the liquid container 4. A stirring blade (not shown) is coupled to an end of the rotary shaft 2 for stirring the liquid in the liquid container 4. The rotary shaft 2 includes a shaft body 20 and a sleeve 21 fixed around the shaft body 20.

The stirring unit 3 is mounted to the rotational members of the sealing device 1 and provided on an outer circumference of the shaft tube 12. Furthermore, the stirring unit 3 is in contact with the liquid received in the liquid container 4. The stirring unit 3 may include at least one blade (single helical blade or a plurality of helical blades) or at least one helical groove. Preferably, the stirring unit 3 is located adjacent to the abutting section formed between the rotational frictional ring 121 and the fixed frictional ring 112 for driving nearby liquid, thereby creating stirring currents near the abutting section.

Preferably, the stirring unit 3 extends in a direction for driving the liquid away from the abutting section. With reference to FIG. 1, liquid is driven by the stirring unit 3 to a left side or operating side (i.e., the interior of the liquid container 4). Namely, when the rotary shaft 2 turns clockwise (as viewed from a right side of FIG. 1), the blade or groove of the stirring unit 3 has a right-hand helix. On the other hand, the blade or groove of the stirring unit 3 has a left-hand helix when the rotary shaft 2 turns counterclockwise. Hence, the stirring currents created by the stirring unit 3 are capable of bringing solid substances (such as impurities) away from the abutting section.

Still referring to FIG. 1, in operation, the rotary shaft 2 drives the shaft tube 12 to turn relative to the main body 11 and the liquid container 4. Meanwhile, the stirring unit 3 turns jointly with the shaft tube 2, thereby creating stirring currents surrounding the stirring unit 3. Since the stirring unit 3 is mounted adjacent to the abutting section formed between the rotational frictional ring 121 and the fixed frictional ring 112, the stirring currents created by the stirring unit 3 cause flow of the liquid near the abutting section to prevent suspended impurities in the liquid from accumulating in the abutting section. Furthermore, flowing of the liquid enhances the heat-dissipating heat and, thus, maintains rotational smoothness and assembling reliability.

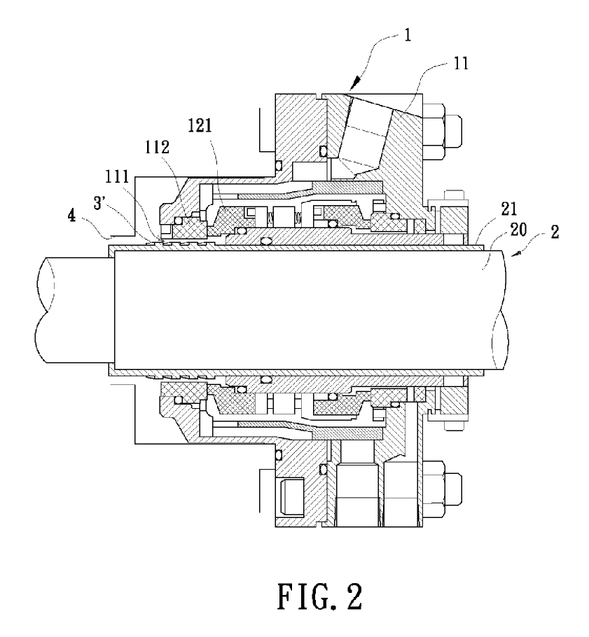

FIG. 2 illustrates a second embodiment of the shaft sealing assembly in accordance with the present invention. In this embodiment, the stirring unit 3′ is provided on an outer circumference of the sleeve 21. In a case that the sleeve 21 is omitted, the stirring unit 3′ is directly provided on an outer circumference of the shaft body 20. Similar to the above embodiment, stirring currents are created by the stirring unit 3′ to prevent suspended impurities in the liquid from accumulating in the abutting section while maintaining rotational smoothness and assembling reliability.

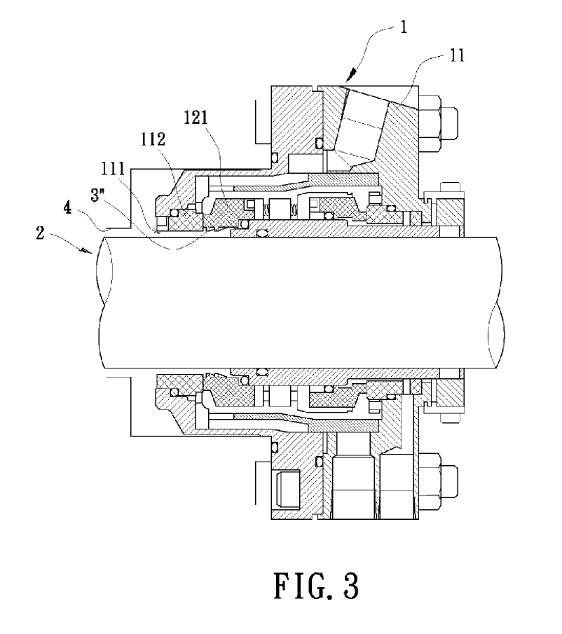

FIG. 3 illustrates a third embodiment of the shaft sealing device in accordance with the present invention. In this embodiment, the stirring unit 3″ is provided on an inner circumference of the rotational frictional ring 121 and includes helical blade(s) or helical groove(s) facing the rotary shaft 2. Similar to the above embodiment, stirring currents are created by the stirring unit 3″ to prevent suspended impurities in the liquid from accumulating in the abutting section while maintaining rotational smoothness and assembling reliability. The sleeve 21 of the rotary shaft 2 may be omitted, and the shaft tube 12 is directly mounted to the rotary shaft 2.

As apparent from the foregoing, the problems of the conventional shaft sealing devices are avoided by the stirring unit 3, 3′, 3″ in accordance with the present invention that is provided on the rotational members (such as the shaft tube 12 or the rotary shaft 2) and that is located adjacent to the abutting section between the fixed frictional ring 112 and the rotational frictional ring 121. The stirring unit 3, 3′, 3″ in accordance with the present invention creates stirring currents to prevent suspended impurities in the liquid from accumulating in the abutting section. Flow of the liquid also lowers the temperature in the abutting section. The rotational smoothness is maintained and the assembling reliability is assured. Thus, the life of the shaft sealing assembly is prolonged.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A shaft sealing assembly comprising:
a sealing device including a plurality of non-rotational members and a plurality of rotational members, said plurality of non-rotational members including a main body and a fixed frictional ring, said plurality of rotational members including a shaft tube and a rotational frictional ring, the fixed frictional ring abutting against the rotational frictional ring, forming an abutting section between the fixed frictional ring and the rotational frictional ring; and
a stirring unit provided on one of said rotational members for driving a liquid adjacent to the abutting section to create stirring currents for stirring the liquid adjacent to the abutting section.

2. The shaft sealing assembly as claimed in claim 1 wherein the stirring unit includes at least one helical blade.

3. The shaft sealing assembly as claimed in claim 1 wherein the stirring unit includes at least one helical groove.

4. The shaft sealing assembly as claimed in claim 1 wherein said plurality of rotational members further includes a rotary shaft, and wherein the stirring unit is provided on an outer circumference of the rotary shaft.

5. The shaft sealing assembly as claimed in claim 4 wherein the rotary shaft includes a shaft body and a sleeve fixed around the shaft body, and wherein the stirring unit is provided on the shaft body.

6. The shaft sealing assembly as claimed in claim 4 wherein the rotary shaft includes a shaft body and a sleeve fixed around the shaft body, and wherein the stirring unit is provided on the sleeve.

7. The shaft sealing assembly as claimed in claim 1 wherein the stirring unit is provided on an outer circumference of the shaft tube.

8. The shaft sealing assembly as claimed in claim 1 wherein the stirring unit is provided on an inner circumference of the rotational frictional ring.

9. The shaft sealing assembly as claimed in claim 1 wherein the rotational frictional ring includes an abutting face, and wherein the fixed frictional ring includes an abutting face that abuts against the abutting face of the rotational frictional ring to form the abutting section.

10. The shaft sealing assembly as claimed in claim 9 wherein the stirring unit is adjacent to the abutting section.
